(19) United States
(12) Patent Application Publication
(10) Pub. No.: US 2005/0227559 A1
(43) Pub. Date: Oct. 13, 2005

(54) Adhesive tape

(76) Inventors: Gerard Ternon, Bolbec (FR); Jenci Kurja, Knokke-Heist (BE); Werner Hess, Deurle (BE)

Correspondence Address: MILLIKEN & COMPANY, 920 MILLIKEN RD (M-495), PO BOX 1926, SPARTANBURG, SC, 29304, US

(21) Appl. No.: 10/514,585

(22) PCT Filed: Jun. 10, 2003
(86) PCT No.: PCT/EP03/06059

§ 371 Date: Nov. 16, 2004

(30) Foreign Application Priority Data
Jun. 12, 2002 (GB) 0213431.0

(51) Int. Cl. B32B 27/12

(52) U.S. Cl. 442/149; 442/203; 442/304

(57) ABSTRACT

This invention relates to an adhesive tape comprising a knitted or woven substrate having weft yarns and a layer of adhesive coated onto the substrate. The substrate is closed to substantially prevent the passage of adhesive through it.

This invention relates to an adhesive tape comprising a knitted or woven layer to which adhesive has been applied, in particular it relates to such tapes in which the fabric layer has weft yarns running substantially parallel to one another across the tape to guide the tearing of the tape.

Adhesive tapes comprising a fabric substrate and adhesive on one surface of the tape are well known. Originally most such tapes employed woven fabrics as the fabric substrate. This substrate was fixed to a film of impermeable material such as polyethylene film and pressure sensitive adhesive was then applied to and through the substrate to bond the substrate to the film and to provide the adhesive for the tape. One function of the film was to prevent adhesive from contacting the next layer of tape when it was wound onto a roll.

The tearability of woven tapes was found to be unsatisfactory so an improved adhesive tape was described in U.S. Pat. No. 4,304,813. The improvement was to use a warp knit, weft inserted, continuous filament fabric substrate in place of the woven fabric substrate. To manufacture the adhesive tape the fabric substrate is pre-formed and then mated with a polyethylene film by nipping between two calender rolls. The first calendar roll is supplied, by a kiss roll, a rubber gum pressure sensitive adhesive which is pressed into and through the fabric substrate to laminate the fabric substrate to the film to provide the pressure sensitive tape when allowed to set after passing through the nip of the calender rolls. Such tapes are expensive to manufacture because of the amount of glue that is not available for use in the final tape due to it being effectively “sunk” into recesses in the substrate or used to join the substrate to the film.

To reduce the substrate cost open substrate constructions such as those described in WO01/83632 are known. Here a polymer film is extruded onto an open reinforcement or substrate layer of weft insertion warp knit fabric. Unless the adhesive is coated onto the film instead of the substrate these open constructions still suffer from the problem of the sunken adhesive due to the openness of the substrate before it is coated with polymer. WO01/83632 says that the open construction substrate fabric may optionally be manufactured such that it includes tape yarns in the weft and/or warp. Reinforcement layers with yarns in tape form, including co-extended tape and filament yarn to which functional sizing has been applied are disclosed.

An alternative approach which also uses tape yarns is taken in EP 0 848 048. Here the fabric substrate is a woven layer whose warp and weft are thermoplastic resin flat yarns. The substrate has a film of polyethylene laminated to one or both surfaces before adhesive is applied to the film. This solves the problem of wastage of adhesive due to it sinking into the fabric substrate because no adhesive is applied to the woven fabric substrate.

The need to laminate or extrude a thermoplastic film to the fabric substrate between the time that the substrate is manufactured and the final application of adhesive is a disadvantage because it is an extra process step and the product complexity in also increased due to the presence of one, or even two, films to the fabric substrate.

U.S. Pat. No. 4,654,254 describes a medical athletic tape comprised of cotton warp yarns and textured polyester weft yarns having a layer of adhesive disposed thereon. The denier of the textured polyester weft yarn may be between 40 to 200. The textured yarn is said to fill spaces in the fabric and to prevent the adhesive from penetrating through the fabric. The weft yarn count is 20 to 50 and preferably 40 per inch (per cm approx. 8 to 20 and 15.7 preferred)

A further approach has been to use a closed non-woven material for the substrate. These are known for example from U.S. Pat. No. 5,631,073, DE 29819014, DE19523494, WO01/16245, EP1116764 and EP0668336. DE19523494 describes the thermal calendering of spun bonded polypropylene before adhesive is applied. The calendering gives a flatness of 10 to 30%. Non-woven substrates suffer from the disadvantage of poor directional tearability due to the absence of any weft yarns to guide a tear across the tape.

According to the present invention there is provided an adhesive tape comprising a knitted or woven substrate having weft yarns and a layer of adhesive coated onto the substrate, characterised in that the substrate is closed to substantially prevent the passage of adhesive through it. For the reasons explained hereafter the weft count is preferably less than 15 per cm and more preferably lies in the range 1 to 10 per cm, most preferably in the range 1 to 5 per cm.

The weft is preferably substantially flat. By substantially flat we mean that the ratio of the thickness to width of the yarn in the adhesive tape is at least 4 and preferably it is at least 8 and more preferably it is at least 20 and using available tape yarns it may be as high as about 100. That is to say the width of the tape yarn is 100 times its thickness.

Use of a knitted substrate is preferred because it provides a more stable and geometric fabric than use of a woven substrate. Most preferred is a weft insertion warp knit (WIWK) substrate in which the weft yarn is a higher decitex than the knit yarn. A WIWK construction means that all of the weft yarns are on one face of the fabric. This contrasts with woven constructions where the weft yarns are located on both faces of the fabric and are split apart by the warp yarns. Particularly for embodiments where heat calendering is used to close the fabric the advantage of having all the weft yarns lying in the same plane on the same face of the fabric is considerable. In some cases it is even possible to reach a final tape construction where the thin weft yarns meld together to form a layer which is similar to the prior art separate or extruded on polymer layer. However, the advantageous difference is that the knit stitching goes around this “layer” to help to hold it in place.

By closed it is intended to mean that during manufacture adhesive does not pass through the substrate to render the other side sticky. If it did this would be a problem for unwinding the tape from a roll. Furthermore it is important that when the tape is unwound substantially no adhesive from the adjacent layer of tape detaches itself and adheres instead to the side of the substrate to which it had not originally been applied. Closure of the substrate also significantly reduces the quantity of adhesive that must be applied as it reduces the proportion of the adhesive that “sinks” into the substrate.

Suitable adhesives for use with the substrate according to the invention may be chosen from the group consisting of rubber based adhesives (both natural and synthetic), acrylic based adhesives, silicone based adhesives and polyurethane based adhesives and combinations thereof. Preferably the adhesive is selected from group consisting of: Natural Rubber, Polyisoprene, Styrene-Isoprene Block Copolymer, Styrene-Butadiene Block Copolymer, Butyl Rubber, Polystyrene-Poly(ethylene/butylene)-Polystyrene, Polystyrene-Poly(ethylene/propylene)-Polystyrene, Polystyrene-Polyisoprene-Polybutadiene, Polybutene, Polyacrylates, Polydiacrylates, Polytriacrylates, Poly methacrylates, Polydimethacrylates, Polytrimethacrylates, Polytetramethacrylates, Polyacrylamides, Polymethacrylamides, Polyacrylimides, Polymethacrylimides, Polymethacrylic acid, Polyacrolein, Polymethacrylonitrile, Poly(maleic acid) and derivatives, Poly(fumaric acid) and derivatives, Poly(crotonic acid) and derivatives, Poly(itaconic acid) and derivatives, Poly(ciraconic acid) and derivatives, Poly(maleamic acid) and derivatives, Poly(vinyl ethers), Polyisocyanates, Polystyrene and derivatives, Polylactones, Polybetaines and compatible mixtures thereof.

The closed substrate may be formed in a number of ways. In one embodiment it may be formed by knitting through an impermeable laminar material into the substrate. Possibly this laminar material is fractured into tapes by being knit into the substrate.

Alternatively and more preferably the closed substrate is created by knitting pre-formed tape-yarns into the substrate during its manufacture and then fusing the tape-yarns and optionally the other yarns in the substrate to create the closed substrate. The fusion may be achieved by passing the substrate through rollers, at least one of which is heated. This provides the advantage of flattening the substrate at the same time as it is closed. The use of one heated roller would suffice as the important thing is to produce a relatively flat closed surface on one side of the substrate. For some types of adhesive this may be the side to which adhesive is applied, for others the adhesive may require to be applied to the less flattened side. The side is chosen that best reduces the tendency for adhesive to transfer or bond to the other surface during storage of the adhesive tape on a roll.

The substrate may alternatively be closed by heating it using hot gas or steam, this technique is particularly effective when shrinkable weft and/or warp yarns are utilised. After such shrinkage the substrate may be flattened by passing it through rollers at least one of which may be heated.

The substrate may, alternatively, include texturised yarns and/or spun yarns. The texturised yarns can be melded and optionally fused to create the closed substrate. For such yarns the melding or fusion is preferably achieved by exposing the substrate to hot gas or steam. The substrate may then be flattened by passing the substrate through rollers, at least one of which is heated. Other types of yarn suitable for use in the substrate either alone or in combination with the above yarns may be selected from bulked yarn, core yarn, bi-component yarns, spun yarns, coated yarn and combinations thereof. Preferably the weft yarns are 1000 dtex or less. Weft yarns with 150 dtex or even as low as 20 dtex may be used.

In some preferred embodiments suitable yarns may be made from any man-made organic materials, any polymers or any blends of polymers, including as examples only and without limitation: silicone grafted polyethylene, poly tetrafluoroethylene (Teflon), fluorinated polyolefins, chlorinated polyolefins, polyethylene (including low density, high density, linear low density, medium density, metallocene catalyzed), polypropylene, EPDM rubber, polyvinyl stearyl carbamate, poly chloro trifluoroethylene (Aclar), polystyrene, polyvinyl chloride, polyamide (including polyamide 4, polyamide 6, polyamide 6,6, polyamide 6,10, polyamide 6,12, polyamide 4,6, polyamide 11, polyamide 12), polyurethane (aliphatic: polyether or polyester, aromatic: polyether or polyester), polyvinylidene chloride, polyethylene terephthalate and copolymers of the same, polybutylene terephthalate and copolymers of the same, poly trimethylene terephthalate and copolymers of the same, copolymers of polyethylene (including ionomers, ethylene acrylic acid, ethylene methyl acrylate, ethylene vinyl acetate, ethylene n-butyl acrylate), polyacrylonitrile, polymethylmethacrylate, polycarbonate, polysulfone, and cellophane and combinations thereof.

In addition, or alternatively, the closed substrate may include natural fibers or mixtures of natural and man made fibres such as cotton or rayon. Yarns made from such fibers are conventionally used in the hygiene and medical tape fields. By utilizing such fibers the present invention is capable of providing alternatives to those types of adhesive tapes.

Particularly important polymers for technical tape applications are polyarylate, polyvinyl alcohol, polyvinyl chloride, polychlal (mix of PVA/PVC), fluorocarbon, phenolic, polyacrylate, poly-benzimidazole, polyetheretherketone, polyetherimide, polyethersulfone, polyphenylenebenzo-bisoxazole and polyphenylene sulphide.

In addition to being in the weft direction of the closed substrate, the closable yarns can also be in warp and/or in one or more bias directions in the fabric. The weft yarns could also be at a bias angle to the machine direction of the fabric and the tape. By making the yarns at an angle in this way their apparent width in the machine direction is increased and this assists in the closing of the substrate. Spun yarns can, however, only be used in weft. It is possible to alternate the type of yarn used in weft. For example a film-tape weft could be alternated with a spun weft. By selection of weft yarns which shrink in length during closure of the fabric substrate it is possible to get a further closing effect due to the warp yarns being made to be closer together, thereby effectively increasing the number of warp ends. This is only possible if the fabric is not held in stretching equipment such as a tenter during the closing process. Similarly by use of a shrinkable warp yarn the wefts can be closed up during heat processing.

The invention will now be further described by way of example only and with reference to the drawings, which are briefly described as:

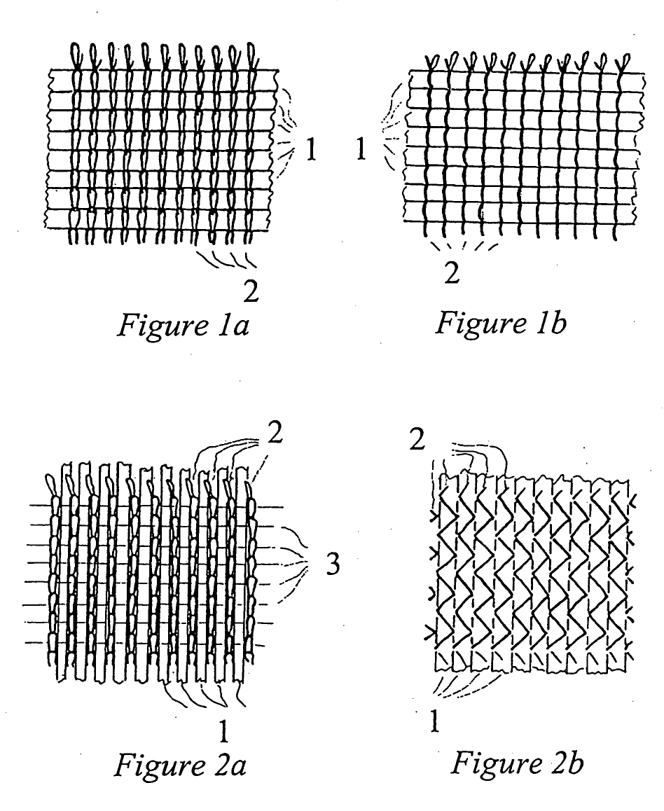

FIG. 1a is the face side of a WIWK fabric with tape yarn weft insertions and chain stitching yarn;

FIG. 1b is the back side of FIG. 1a;

FIG. 2a is the face side of tricot stitch WIWK fabric with tape yarn inlay warp and a weft inserted in each stitch;

FIG. 2b is the back side of FIG. 2a;

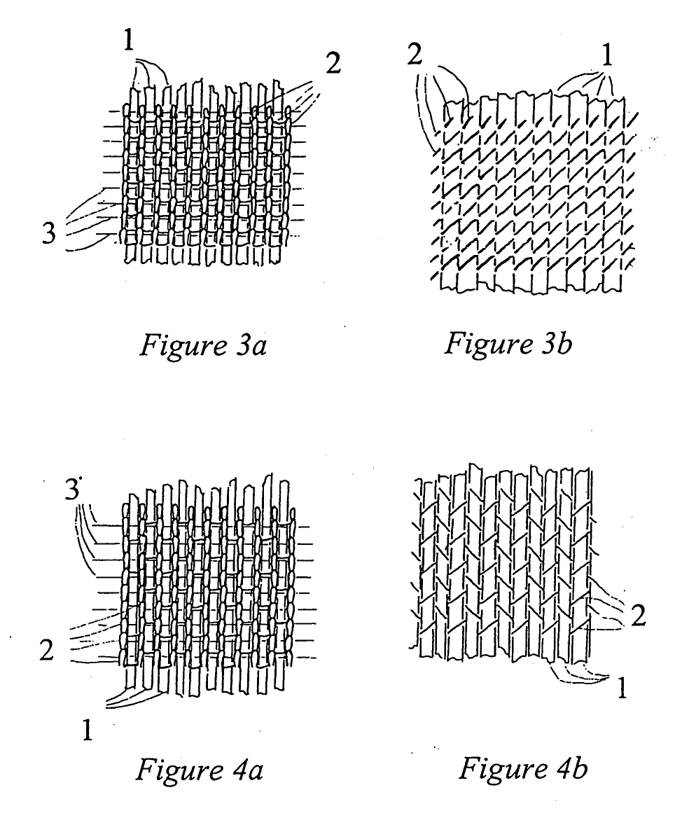

FIG. 3a is the face side of a closed chain stitch working on two needles WIWK fabric with tape yarn inlay warp and a weft inserted in each stitch;

FIG. 3b is the back side of FIG. 3a;

FIG. 4a is the face side of an open tricot stitch working on two needles WIWK fabric with tape yarn inlay warp and a weft inserted in each stitch;

FIG. 4b is the back side of FIG. 4a;

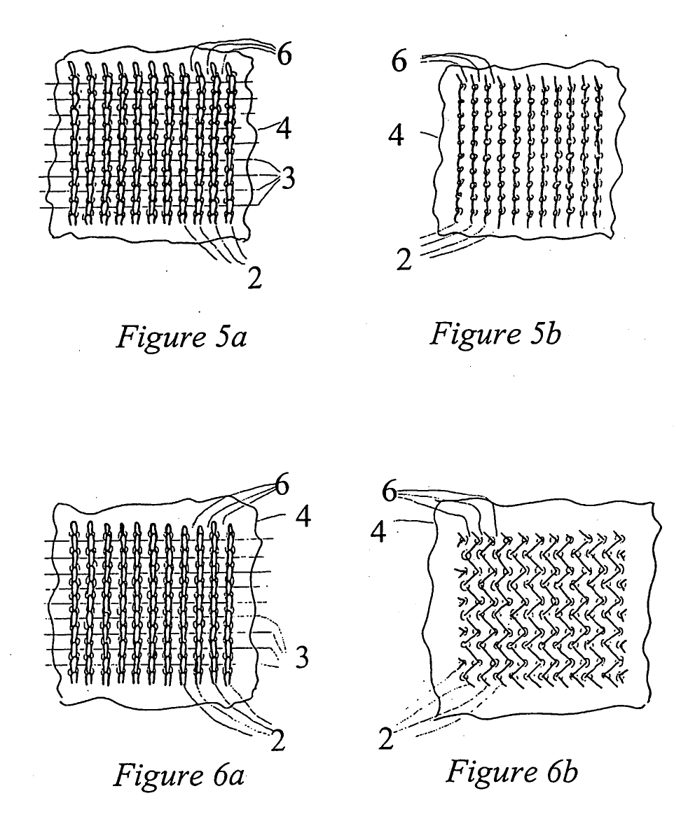

FIG. 5a is the face side of a chain stitch WIWK fabric with a film inserted and stitched through;

FIG. 5b is the back side of FIG. 5a;

FIG. 6a is the face side of a tricot stitch WIWK fabric with a film inserted and stitched through; and with a weft inserted in each stitch; and

FIG. 6b is the back side of FIG. 6a.

FIG. 1a shows the stitched side, or face side, or technical side of a WIWK fabric. FIG. 1b is the back side, or between the stitches, side of the same WIWK fabric. Film-tape weft yarns 1 are inserted into the fabric using a weft insertion warp knit process. To avoid twist being imparted to the film-tapes as they unwind from the bobbins it is desirable to use a creel which has a rotating weft bobbin that rotates one turn for each turn of yarn taken from the bobbin. Such a creel is, for example, manufactured by Karl Mayer of Germany.

By hot calendering either, or both, surfaces the film-tape 1 can be sufficiently modified to form a substantially impermeable surface onto which adhesive can be applied directly by means of a roller or blade or some other conventional adhesive applicator.

Additionally the film-tape 1 can be used in the warp direction (FIGS. 2a, 2b, 3a, 3b, 4a and 4b).

FIGS. 2a and 2b show a WIWK fabric made with a tricot stitch 2 with closed stitches 1,0/1,2 or opened stitches 0,1/2,1. In this embodiment the film-tape is used as an inlay warp (0,0/0,0). It is also necessary to use a weft yarn 3, which can be almost any type of yarn normally used to guide the tearability of the fabric.

FIGS. 3a and 3b show a similar fabric to that of FIGS. 2a and 2b except that a chain stitch 2 working on two needles with closed stitched (0,2/0,2) is used.

FIGS. 4a and 4b show another fabric similar to FIGS. 3a and 3b working on a tricot stitch with two needles with open stitches (0,2/3,1).

In the embodiments of FIGS. 2, 3 and 4 the film-tapes may be fused together by hot calendering before adhesive is applied. For these embodiments where the film-tape is used in the warp direction it is more difficult to get the required impermeability from just the film-tape alone. Accordingly it is desirable that the other yarns be of similar thermoplastic material to enable then to fuse to the film-tapes and to provide a higher degree of impermeability.

The embodiment of FIGS. 1a and 1b are preferred because they allow engineering of the desired property of tearability in the weft direction. They may also eliminate the need for a separate weft yarn. In one particularly preferred variant of FIGS. 3 and 4 the weft yarn is also a tape yarn to give a lattice of tape yarns.

As an alternative to the insertion of tape yarns the tapes can, in effect, be created in situ by the insertion of a plain film 4 during the knitting as shown in FIGS. 5a, 5b, 6a and 6b. The stitch through needles will cut the film in parallel tapes corresponding to the width between two needles 6. The plain film is shown inserted above the weft inserted and therefore the weft can be seen only on the face side. Alternatively it is possible to produce a fabric with the plain film inserted beneath the weft insert.

The film tapes, plain film precursors of film tapes, texturised yarns, or spun yarns may be formed of any low melting point thermoplastic materials such as polyolefins: for example polyethylene or polypropylene. When using film or a warp inlay tape, a weft yarn may be used to define the tearing direction of the technical tape. Use of a sufficiently high denier yarn will ensure that a tear runs across the tape in a straight line, as the tear will not cross the inlaid weft yarn. The film tapes or plain film precursors of film tapes can be formed of elastic or deformable material to give stretch or elastic properties to the tape. A maximum elasticity of 35% is desirable. Especially preferred are elastomeric or non-fixed pre-oriented yarn materials.

Using the thermoplastic weft yarns in bias direction defines a bias tearing direction for the technical tape.

The preferred WIWK construction using a film tape yarn in weft is a chain stitch 2 with closed or open stitches and a film tape weft inserted in each stitch as shown in FIGS. 1a and 1b.

The preferred WIWK construction for a stitched though plain film is a stitching yarn using a tricot stitch 1.0/1,2 with closed stitches or with opened stitches 0,1/2,1 and a weft inserted yarn 3 in each stitch.

The preferred yarn used in the warp for the stitch yarn should be polyester or polyamide from 20 denier (22 decitex) to 150 denier (167 decitex) with flat or textured continuous filament yarns.

The number of warp ends will depend on the number of needles per cm or the gauge. 7.1 warp ends per cm is 18 needles per inch or 18 gauge. The preferred number of ends per cm is from 2 to 16.

The use of a polyolefin stitching yarn (multifilament flat or textured) gives the possibility to produce a 100% polyolefin WIWK fabric tape substrate. Then with the use of a suitably compatible adhesive the entire tape may be recycled. Even without a suitable adhesive any waste substrate up to the point of application of the adhesive may advantageously be recycled.

The preferred construction has a weft film-tape inserted in each stitch. The film tape is advantageously a polypropylene film-tape yarn and the width of the film-tape corresponds to the length of the stitch. As the length of the stitch is the inverse of the number of stitches per cm (or per inch), and as the preferred constructions in weft are between 1 and 10 wefts per cm. For 1 weft per cm the preferred width of the film tape should therefore be lcm and for 10 wefts per cm the preferred width of film tape should be 1 mm. The most preferred weft count lies in the range 1 to 5 per cm. The width of the weft may be smaller than the length of the stitch. In that case, it is particularly preferred that shrinkable warp yarns are used which, after shrinkage, e.g. after heating using hot gas or steam, provide a length of the stitch that essentially corresponds to the width of the weft.

The thickness of the film tape will depend on the desired thickness of the eventual adhesive tape product. The preferred thickness will be in the range 0.1 to 0.5 mm. But a thickness of from 0.025 mm up to 1 mm is possible technically.

It is possible to use a plain film with a weft insertion of another film-tape of a different material to obtain a substrate having two sides with different properties, for example one material with high substantivity to the adhesive and one with low substantivity to the adhesive. One variant desirably combines polypropylene and polyethylene in this way.

### EXAMPLE

A sample tape was made using a weft insertion yarn of 900 dtex BCF polypropylene. It was calendered at by passing through a hot roller (160 deg C.) and when viewed optically it was seen to be almost fully closed. Use of higher decitex yarn did not close the substrate so effectively. This is thought to be because it is harder to melt the higher decitex yarn by passing it through a single roller. Use of multiple rollers would solve this problem. For the 900 dtex sample the yarn remained profiled on one side and was flat on the other side due to the action of the roller.

The flat side was then coated with an adhesive in the manner conventional for tape manufacture. The resulting adhesive tape for tested for adhesion to the non-calendered side of the tape. It peeled well leaving no detectable traces of adhesive.

1-30. (canceled)

31. An adhesive tape, the adhesive tape comprising a weft insertion warp knit substrate and a layer of adhesive coated onto the substrate, wherein the substrate comprises fused closable yarns in the weft direction and wherein the substrate is closed to substantially prevent the adhesive from passing therethrough.

32. The adhesive tape of claim 31, wherein the weft insertion warp knit substrate comprises a plurality of knit yarns and a plurality of weft yarns, and wherein said weft yarns are of a higher decitex than said knit yarns.

33. The adhesive tape of claim 32, wherein at least a portion of the weft yarns is spun yarns.

34. The adhesive tape of claim 32, wherein the weft yarns are 1000 decitex or less.

35. The adhesive tape of claim 32, wherein from 1 to 10 weft yarns per centimeter are present in the weft of the weft insertion warp knit fabric.

36. The adhesive tape of claim 35, wherein from 1 to 5 weft yarns per centimeter are present in the weft of the weft insertion warp knit fabric.

37. The adhesive tape of claim 31, wherein, when the adhesive tape is unwound, substantially no adhesive transfers from the adhesive layer of the adhesive tape to the exposed, non-adhesive side of the adjacent substrate.

38. The adhesive tape of claim 31, wherein the substrate comprises yarns, said yarns being comprised of materials selected from the group consisting of man-made organic materials, polymers, and blends of polymers.

39. The adhesive tape of claim 38, wherein said yarns are selected from the group consisting of silicone grafted polyethylene, poly tetrafluoroethylene, fluorinated polyolefins, chlorinated polyolefins, polyethylene (including low density, linear low density, medium density, high density, and metallocene catalyzed), polypropylene, EPDM rubber, polyvinyl stearyl carbamate, poly chloro trifluoroethylene, polystyrene, polyvinyl chloride, polyamide (including polyamide 4, polyamide 6, polyamide 6,6, polyamide 6,10, polyamide 6,12, polyamide 4,6, polyamide 11, and polyamide 12), polyurethane (aliphatic: polyether and polyester, and aromatic: polyether and polyester), polyvinylidene chloride, polyethylene terephthalate and copolymers thereof, polybutylene terephthalate and copolymers thereof, polytrimethylene terephthalate and copolymers thereof, copolymers of polyethylene (including ionomers, ethylene acrylic acid, ethylene methyl acrylate, ethylene vinyl acetate, and ethylene n-butyl acrylate), polyacrylonitrile, polymethylmethacrylate, polycarbonate, polysulfone, cellophane, and combinations thereof.

40. The adhesive tape of claim 38, wherein the yarns are selected from the group consisting of polyarylate, polyvinyl alcohol, polyvinyl chloride, polychlal (a mixture of polyvinyl alcohol and polyvinyl chloride), fluorocarbon, phenolic, polyacrylate, polybenzimidazole, polyetheretherketone, polyetherimide, polyethersulfanone, polyphenylenebenzobisoxazole, and polyphenylene sulphide.

41. The adhesive tape of claim 31, wherein, in addition to the weft direction of the substrate, the closable yarns are present in a direction selected from the group consisting of the warp direction, at least one bias direction, and the warp and at least one bias direction.

42. The adhesive tape of claim 31, wherein the adhesive is selected from the group consisting of natural rubber based adhesives, synthetic rubber based adhesives, acrylic based adhesives, silicone based adhesives, polyurethane based adhesives, and combinations thereof.

43. The adhesive tape of claim 42, wherein the adhesive is selected from the group consisting of natural rubber, polyisoprene, styrene-isoprene block copolymer, styrene-butadiene block copolymer, butyl rubber, polystyrene-poly (ethylene/butylene)-polystyrene, polystyrene-(ethylene/propylene)-polystyrene, polystyrene-polyisoprene-polybutadiene, polybutene, polyacrylates, polydiacrylates, polytriacrylates, polymethacrylates, polydimethacrylates, polytrimethacrylates, polytetramethacrylates, polyacrylamides, polymethacrylamides, polyacrylimides, polymethacrylimides, polymethacrylic acid, polyacrolein, polymethacrylonitrile, poly (maleic acid) and derivatives, poly (fumaric acid) and derivatives, poly (crotonic acid) and derivatives, poly (ciraconic acid) and derivatives, poly (maleamic acid) and derivatives, poly (vinyl ethers), polyisocyanates, polystyrene and derivatives, polylactones, polybetaines, and compatible mixtures thereof.

44. A process for making an adhesive tape, said process comprising the steps of:
(a) providing a knitted substrate, having knit yarns and inserted weft yarns;
(b) fusing at least a portion of the yarns of the knitted substrate to create a substantially closed substrate on at least one side therof; and
(c) applying adhesive to one side of the closed substrate, such that the adhesive does not penetrate through the substrate.

45. The process of claim 44, wherein the knitted substrate comprises tape yarns in the weft direction, the warp direction, or both, said tape yarns being at least partially fused in step (b).

46. The process of claim 44, wherein said tape yarns are formed from a sheet that is fractured into said tape yarns by being knit into the knitted substrate.

47. The process of claim 44, wherein the weft yarns used to create the knitted substrate are positioned on a bias with respect to the knit yarns.

48. The process of claim 44, wherein step (b) occurs by passing the substrate between rollers, at least one of which is heated, to flatten and close the substrate.

49. The process of claim 44, wherein step (b) occurs by heating the substrate with hot gas or steam and flattening the substrate by passing it between rollers, at least one of which is heated.

50. The process of claim 44, wherein between step (b) and step (c), the closed substrate is further flattened by passing between rollers, at least one of which is heated.

51. A substrate useful for the manufacture of an adhesive tape, said substrate comprising a weft insertion warp knit fabric having a plurality of knit yarns and a plurality of weft yarns, wherein at least a portion of the yarns are thermally fusible and the construction of the substrate is such that, when the yarns are fused, the substrate becomes closed.

52. The substrate of claim 51, wherein the substrate comprises spun yarns.

53. The substrate of claim 51, wherein the substrate comprises texturized yarns.

54. The substrate of claim 51, wherein the substrate comprises tape film yarns.

55. The substrate of claim 54, wherein the tape film yarns are texturized.

56. The substrate of claim 54, wherein the tape film yarns comprise at least one thermoplastic material.
